(19) United States
(12) Patent Application Publication
(10) Pub. No.: US 2019/0327991 A1
(43) Pub. Date: Oct. 31, 2019

(54) FERMENTED MILK AND METHOD FOR MANUFACTURING TWO-LAYER-TYPE FERMENTED MILK PRODUCT

(71) Applicant: MEIJI CO., LTD., Tokyo (JP)

(72) Inventors: Seiji NAGAOKA, Kanagawa (JP); Atsushi MIYAUCHI, Kanagawa (JP); Tomofumi YOSHIDA, Kanagawa (JP); Tetsu KAMIYA, Kanagawa (JP); Kenichi HOJO, Kanagawa (JP)

(21) Appl. No.: 16/461,819

(22) PCT Filed: Nov. 29, 2017
(86) PCT No.: PCT/JP2017/042801

§ 371 Date: May 17, 2019

(30) Foreign Application Priority Data
Nov. 30, 2016 (JP) 2016-232400

(51) Int. Cl. A23C 9/133; A23C 9/142

(52) U.S. Cl. CPC A23C 9/133; A23C 9/1422

(57) ABSTRACT

Provided are a concentrated fermented milk and a production method therefor, in particular, a concentrated fermented milk having an increased viscosity and a production method therefor. Also provided are a two-layer-type fermented dairy product and a production method therefor. A production method for fermented milk which includes: cooling fermented milk after concentrating; and storing the fermented milk at a predetermined temperature for a predetermined period of time to increase a viscosity of the fermented milk. A production method for a two-layer-type fermented dairy product, which includes a layer of a sauce containing fruit pulp and/or fruit juice on fermented milk and is contained in a container, which includes: supplying the fermented milk into the container at a supplying temperature of 15° C. or less; and supplying the sauce on the fermented milk after the supplying of the fermented milk.

### TECHNICAL FIELD

The present invention relates to a concentrated fermented milk and a production method therefor, and more particularly, to a concentrated fermented milk having an increased viscosity and a production method therefor. The present invention also relates to a production method for a two-layer-type fermented dairy product (i.e. a fermented dairy product having two layers as its contents).

### BACKGROUND ART

As a method of increasing a viscosity of concentrated fermented milk, there have hitherto been known: (1) a method involving increasing a milk solid; and (2) a method involving using a stabilizer.

However, (1) the method involving increasing a milk solid has problems in that roughness is generated and cost is increased. In addition, (2) a method involving using a stabilizer has a problem in that a natural texture that the concentrated fermented milk originally has is lost.

As a general production method for concentrated fermented milk, it has been proposed that fermented milk be concentrated at 40° C. with an ultrafiltration membrane (UF membrane), and then supplied into a container at 20° C., followed by cooling to 5° C. (see Non-Patent Literature 1).

In addition, there has been proposed a production method for stirred fermented milk involving performing supplying into a container through cooling and smoothing after fermentation in a tank (see Non-Patent Literature 2). In Non-Patent Literature 2, there is a disclosure that a high supplying temperature results in a high viscosity of fermented milk after the cooling, and there is a description that it is generally desired to perform the supplying at a temperature of about 20° C., followed by rapid cooling to 10° C. or less.

However, when the supplying is performed at a temperature of about 20° C., or at a higher temperature, the following feature is found: a viscosity of the fermented milk immediately after the supplying is extremely low as compared to a viscosity after the cooling.

In addition to the foregoing, as a method of suppressing a reduction in viscosity of a finished product, in Non-Patent Literature 2, there is a report that, when shearing during production steps is suppressed and yogurt after fermentation is treated at an appropriate temperature for an appropriate period of time, the viscosity of the product is increased.

Concentrated fermented milk having an increased viscosity may be turned to a two-layer-type fermented dairy product through utilization of its increased viscosity.

In order to maintain an interface between a fermented milk layer and a food layer in production of the two-layer-type fermented dairy product, it is known that gelling agents, such as LM pectin and gelatin, are added to both the fermented milk layer and the food layer (see Patent Literature 1).

However, when the gelling agents are used, a problem arises in that a milk flavor is impaired, leading to a reduction in value of the product as a whole.

In addition, there is a proposal of a production method for multilayered fermented milk involving forming a jelly layer on fermented milk through use of an umbrella-type nozzle (see Patent Literature 2).

However, this method requires a mechanism configured to drive the umbrella-type nozzle up and down at the time of supplying, and hence has a problem in that an existing supplying machine cannot be applied as it is.

An investigation made by the inventors of the present application has found that, among concentrated fermented dairy products in Japan, there is a two-layer-type product in which a sauce is supplied as a lower layer, but there is no product in which a sauce is supplied as an upper layer.

This also suggests that, in the conventional production methods, the viscosity of the fermented milk at the time of supplying is low, and hence it is difficult to supply a sauce as an upper layer.

### CITATION LIST

### Patent Literature

[Patent Literature 1] JP 2815363 B2
[Patent Literature 2] JP 2013-013339 A

### Non-Patent Literature

[Non-Patent Literature 1] A. Y. Tamime and R. K. Robinson, “Woodhead Publishing in Food Science and Technology, Yoghurt Science and Technology, second edition” (publishing country: England, USA, publisher: Woodhead Publishing Limited, CRC Press LLC, published in 1999), p. 332
[Non-Patent Literature 2] Tadao Saito, Hiroyuki Ito, Keiji Iwatsuki, and Toshimitsu Yoshioka (Eds.), “Encyclopedia of Yogurt” (Asakura Publishing Co., Ltd., Tokyo, published in Tokyo in 2016), p. 113

### SUMMARY OF INVENTION

### Technical Problem

An object of the present invention is to propose a concentrated fermented milk and a production method therefor, in particular, a concentrated fermented milk having an increased viscosity and a production method therefor.

Another object of the present invention is to propose a two-layer-type fermented dairy product and a production method therefor.

### Solution to Problem

In investigating fermented milk having a high viscosity that can be produced without unnecessarily increasing a milk solid or using any stabilizer in production steps for the fermented milk, the inventors of the present application first investigated a hitherto known production method.

<Preparation of Concentrated Fermented Milk>

The preparation of concentrated fermented milk involving performing a concentrating step (i.e. whey removal) after fermentation, and the production of a two-layer-type fermented dairy product using the obtained concentrated fermented milk have hitherto generally been performed through steps illustrated in FIG. 1.

The inventors of the present application performed tests on a hitherto known technology by producing concentrated fermented milk as described below in accordance with the production flow illustrated in FIG. 1, and producing a two-layer-type fermented dairy product using the obtained concentrated fermented milk.

As described later, a fermented milk and a production method therefor, and a two-layer-type fermented dairy product and a production method therefor proposed by the present invention are such that, in the production flow illustrated in FIG. 1, cooling step, aging step and supplying step after curd crushing step and concentrating step are performed under predetermined conditions.

Therefore, also in an embodiment and Examples of the present invention, which are described later, the concentrated fermented milk is produced in the same manner as described below except that cooling step, aging step and supplying step after curd crushing step and concentrating step are performed under predetermined conditions described in the embodiment and Examples of the present invention, and the two-layer-type fermented dairy product is produced using the concentrated fermented milk.

First, raw materials (i.e. 490 g of powdered skim milk, 80 g of milk protein, and 4,280 g of water) were mixed to prepare a blended liquid whose components had been adjusted to achieve a total solid content of 11.1%, a fat content of 0.1%, and a protein content of 4.8%.

Herein, “%” means “mass % (i.e. weight %)” unless otherwise specified.

The blended liquid was pasteurized with a continuous plate heat exchanger under the conditions of 95° C. and 5 minutes, and was cooled to 43° C. After that, the blended liquid was inoculated with a lactic acid bacterial starter (i.e. a mixed starter of a bulgaricus strain OLL205013 (accession number: NITE BP-02411) and a thermophilus strain OLS3290 (accession number: FERM BP-19638)) in an amount of 3 parts (i.e. 150 g) by mass with respect to 97 parts by mass of the blended liquid, and was fermented until the pH of the blended liquid reached 4.55.

Details of those strains are as described below.

### (a) Bulgaricus Strain OLL205013

Lactobacillus delbrueckii subsp. bulgaricus strain OLL205013 was internationally deposited to NITE (i.e. National Institute of Technology and Evaluation) Patent Microorganisms Depositary with an accession number of NITE BP-02411 on Feb. 3, 2017 (date of the original deposit).

### (b) Thermophilus Strain OLS3290

Streptococcus thermophilus strain OLS3290 was domestically deposited to NITE (i.e. National Institute of Technology and Evaluation) Patent Microorganism Depositary on Jan. 19, 2004 (domestic deposit date), and then, by conversion to an international deposit, internationally deposited with an accession number of FERM BP-19638 on Sep. 6, 2013.

After the completion of the fermentation, the resultant curd (i.e. product of the fermentation of the blended liquid) was cooled to 10° C. or less, and then the curd was crushed by stirring. Whey (i.e. light liquid) was separated with a nozzle separator (KNA-3: manufactured by GEA Westfalia Separator). Thus, concentrated fermented milk (i.e. heavy liquid) was obtained.

At this time, a concentration factor was adjusted so that the concentrated fermented milk (i.e. heavy liquid) had a protein concentration of 10%.

The concentrated fermented milk (i.e. heavy liquid) was cooled with a continuous tube heat exchanger to provide concentrated fermented milk (i.e. fermented milk of the present invention).

The concentration factor C was determined by the following equation:

C=F/Q=F/(F−W)

where F represents the mass flow rate [kg/h] of a fed liquid, Q represents the mass flow rate [kg/h] of the concentrated fermented milk (i.e. heavy liquid), and W represents the mass flow rate [kg/h] of the whey (i.e. light liquid).

98 g (see “Test 2” to be described later) or 84 g (see “Example 3” to be described later) of the concentrated fermented milk was supplied into a plastic cup, its surface was smoothed flat, and then 42 g (see “Test 2” to be described later) or 36 g (see “Example 3” to be described later) of a fruit pulp-containing sauce prepared in advance was supplied thereon.

The concentrated fermented milk prepared in accordance with the foregoing was used as the object of the following experiments, and the temperature of cooling after concentrating (as well as the aging temperature in a tank) or the supplying temperature were variously adjusted.

<Evaluation Methods>

### [Viscosity Measurement]

The viscosity of the fermented milk was measured using a B-type viscometer TVB-10 (manufactured by Toki Sangyo Co., Ltd.). More specifically, the value of the viscosity of a sample (i.e. concentrated fermented milk) after 30 seconds at 30 rpm was measured using a No. 4 (M23) rotor.

[Sensory Evaluation]

The fermented milk aged or supplied (i.e. packed) under various conditions was stored at 10° C. for 12 hours, and was then sampled (i.e. tasted) to be evaluated for its flavor.

[External Appearance Evaluation of Two-Layer-Type Fermented Milk]

A fruit juice- or fruit pulp-containing sauce was immediately supplied on the fermented milk which had been aged or supplied under various conditions, and an external appearance was evaluated by visual observation.

<Test 1 on Hitherto Known Technology>

The fermented milk after the concentrating was cooled to 20° C. and 98 g of the cooled fermented milk was supplied into a container, immediately followed by viscosity measurement.

In addition, a sample (i.e. a specimen) rapidly cooled to 10° C. or less after being supplied into a container and stored for 12 hours was also evaluated in the same manner.

Further, a sample obtained by supplying the fermented milk after the concentrating into a container at 40° C. was also evaluated at two time points in the same manner as described above.

The results were as shown in Table 1.

TABLE 1

| | Concentrated | Concentrated |
|---|---|---|
| | fermented milk | fermented milk |
| | supplied at 20° C. | supplied at 40° C. |
| Viscosity immediately | 3,250 | 2,060 |
| after supplying (cp) | | |
| Viscosity after storage | 7,860 | 14,910 |
| at 10° C. for 12 hours (cp) | | |

As shown in Table 1, in the case of the 20° C. supplying, the fermented milk immediately after the supplying had a viscosity of 3,250 cp, but was thickened to 7,860 cp when stored at 10° C. for 12 hours.

In the case of the 40° C. supplying, the fermented milk immediately after the supplying had a viscosity of 2,060 cp, but was thickened to 14,910 cp when stored at 10° C. for 12 hours.

It was able to be confirmed from the results that, as reported in Non-Patent Literature 2, “a high supplying temperature results in a high viscosity of fermented milk after cooling.”

<Test 2 on Hitherto Known Technology>

98 g of the fermented milk after the concentrating was supplied into a container at 20° C. or 40° C., and immediately after that, 42 g of a kiwi sauce was supplied. The external appearance of the two-layer-type fermented milk was evaluated.

The kiwi sauce contained 18.2 mass % of kiwi fruit pulp, 26.5 mass % of sugar, 0.6 mass % of LM pectin, and water. A spool nozzle filling machine FX-01 (Shikoku Kakoki Co., Ltd.) was used for the supplying of the sauce.

As shown in A and B of FIG. 2, the concentrated fermented milk supplied at 40° C. failed to exhibit a two-layer state, because the kiwi sauce sank into the fermented milk.

As shown in C and D of FIG. 2, the concentrated fermented milk supplied at 20° C. did not have the sauce spread over its entire upper surface, because part of the sauce sank into the fermented milk.

In FIG. 2, the results of two experiments performed under the same conditions are shown as A and B. In FIG. 2, the results of two experiments performed under the same conditions are shown as C and D.

The results demonstrated that the hitherto known technology was capable of increasing the viscosity of fermented milk in a container by performing supplying at about 20° C., followed by rapid cooling, but had extreme difficulty in supplying a fruit juice- or fruit pulp-containing sauce as an upper layer on the fermented milk.

It was found from the test on the hitherto known technology described above that the methods described in Non-Patent Literatures 1 and 2, which involve supplying concentrated fermented milk at 20° C., and immediately after that, supplying a sauce containing, for example, fruit pulp or fruit juice on the concentrated fermented milk, had a problem in that the sauce sank into the concentrated fermented milk, or the sauce did not spread over the entire surface of the concentrated fermented milk, because the concentrated fermented milk had a low viscosity.

As described above, high-viscosity physical properties can be expressed without unnecessarily increasing a milk solid or using any stabilizer in production steps for fermented milk. In particular, fermented milk having a high viscosity can be produced without using any stabilizer. However, when the maintenance of such advantage is assumed, it has been found that novel solving means needs to be proposed in order to produce two-layer-type fermented milk capable of maintaining two layers even when a sauce containing, for example, fruit pulp or fruit juice is supplied on the fermented milk.

As described above, in Non Patent Literature 2, there is a report that, when shearing during production steps is suppressed and yogurt after fermentation is treated at an appropriate temperature for an appropriate period of time, the viscosity of the product is increased.

The inventors of the present application have made extensive investigations from a perspective different from the suppression of shearing, with a view to producing fermented milk having a high viscosity without adopting new apparatus, equipment, or the like in addition to apparatus and equipment hitherto adopted in the hitherto known production steps illustrated in FIG. 1.

The inventors of the present application have completed the invention of the present application by focusing their attention on the temperature management of fermented milk in a buffer tank, and a surge tank or a filling (i.e. supplying) machine. The invention of the present application is as described below.

[1] A production method for fermented milk, including: cooling fermented milk after concentrating; and storing the fermented milk at a predetermined temperature for a predetermined period of time to thereby increase a viscosity of the fermented milk.
[2] The production method for fermented milk according to Item [1], wherein the concentrating of the fermented milk before the cooling is performed using a separator or a UF membrane.
[3] The production method for fermented milk according to Item [1] or [2], wherein the predetermined temperature is 15° C. or less.
[4] The production method for fermented milk according to any one of Items [1] to [3], wherein the predetermined period of time is 1 hour or more.
[5] The production method for fermented milk according to any one of Items [1] to [4], wherein, through (i.e. by means of) the storing at the predetermined temperature for the predetermined period of time, the viscosity of the fermented milk is increased after the storing as compared to that before the storing by 1,000 cp or more.
[6] The production method for fermented milk according to Item [5], wherein the viscosity of the fermented milk after the storing is 4,000 cp or more.
[7] A production method for a two-layer-type fermented dairy product that includes a layer of a sauce containing fruit pulp or fruit juice (i.e. any one or both of the fruit pulp and the fruit juice) on fermented milk and is contained in a container, the production method including: supplying the fermented milk into the container at a supplying temperature of 15° C. or less; and supplying the sauce on the fermented milk after the supplying of the fermented milk.
[8] The production method for a two-layer-type fermented dairy product according to Item [7], wherein the fermented milk is a fermented milk produced by the production method of any one of Items [1] to [6].

### Advantageous Effects of Invention

According to the present invention, the concentrated fermented milk and the production method therefor, in particular, the concentrated fermented milk having an increased viscosity and the production method therefor can be provided.

In addition, according to the present invention, the two-layer-type fermented dairy product and the production method therefor can be provided.

### BRIEF DESCRIPTION OF DRAWINGS

FIG. 1 is a production flow for illustrating an example of production steps of the present invention.

FIG. 2 is a reference photograph for showing the state of a two-layer-type fermented dairy product produced by a conventional production method as viewed from above.

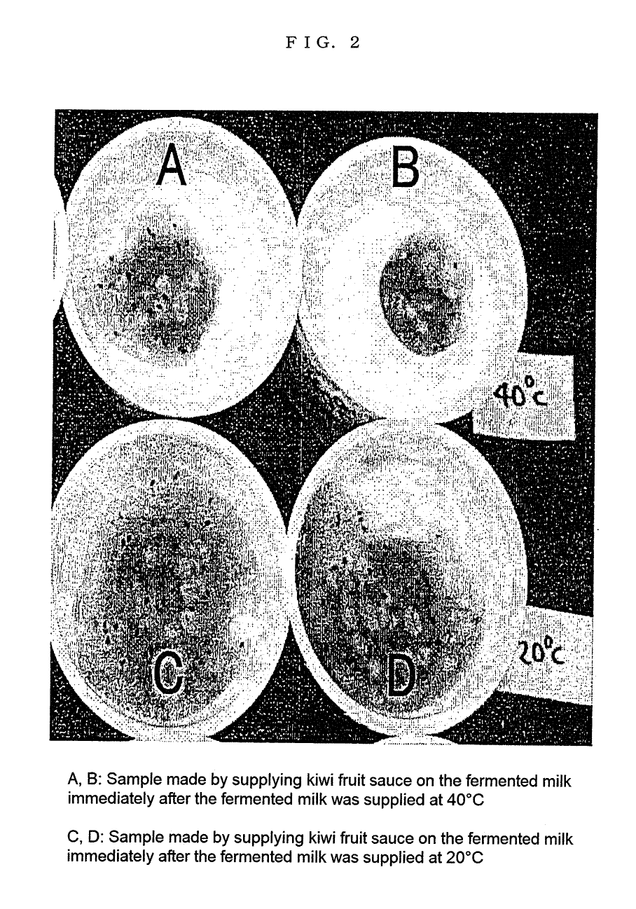

FIG. 3 is a reference photograph for showing the state of a two-layer-type fermented dairy product produced by a production method of the present invention as viewed from above.

### DESCRIPTION OF EMBODIMENTS

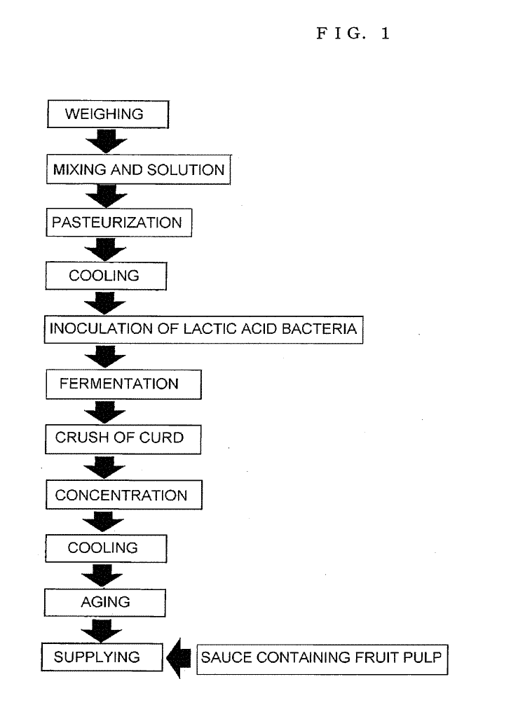

In this embodiment, in accordance with a production flow illustrated in FIG. 1, as described below, concentrated fermented milk is produced by performing a concentrating step (i.e. whey removal) after fermentation, and a two-layer-type fermented dairy product is produced using the concentrated fermented milk after its production. As for means for the concentrating step after fermentation, any known means may be adopted, but a separator and/or a UF membrane is desired.

A fermented milk and a production method therefor, and a two-layer-type fermented dairy product and a production method therefor according to this embodiment are such that, in the production flow illustrated in FIG. 1, cooling step, aging step, and supplying (i.e. charging, filling or packing) step after curd crushing step and concentrating step (i.e. condensation step) are performed under predetermined conditions, and the other steps are similar to steps that have hitherto generally been performed. Therefore, the steps unique to this embodiment are mainly described below.

In this embodiment, fermented milk after concentrating is cooled, and stored at a predetermined temperature for a predetermined period of time to thereby increase a viscosity of the fermented milk.

According to an investigation made by the inventors, when aging was performed at a predetermined temperature after cooling for a predetermined period of time, fermented milk having thick physical properties was able to be produced without an increase in its composition (e.g., the ratio of a milk solid). In the present invention, as a suitable composition, a protein concentration is preferably from 3% to 15%, more preferably from 5% to 13%, still more preferably from 8% to 12%, and particularly preferably from 9% to 11%.

The fermented milk having its viscosity increased by aging in a storage tank, such as a surge tank, as described above is driven out to the next step by stirring the inside of the tank with a stirring element or the like. In this case, as the stirring element, a known stirring element may be used, and a form that does not significantly lower the viscosity of the fermented milk, such as a large stirring blade or a ribbon-type stirring element, is desired.

The achievement of the fermented milk having an increased viscosity has enabled the production of fermented milk capable of maintaining two layers even when a sauce containing, for example, fruit pulp or fruit juice is supplied on the fermented milk.

When the aging is performed at the predetermined temperature after the cooling for the predetermined period of time, not only fermented milk having an increased viscosity can be produced, but also fermented milk having less sourness can be produced.

In the foregoing, the concentrating of the fermented milk before the cooling may be performed using a separator or a UF membrane.

The predetermined temperature in the storage to be performed at the predetermined temperature after the cooling for the predetermined period of time is preferably 15° C. or less, more preferably 12° C. or less, and particularly preferably 10° C. or less. In addition, the predetermined temperature in the storage to be performed at the predetermined temperature after the cooling for the predetermined period of time is preferably 0° C. or more, more preferably 2° C. or more, and particularly preferably 5° C. or more.

The predetermined period of time is preferably 1 hour or more, more preferably 2 hours or more, and particularly preferably 3 hours or more. In addition, the predetermined period of time is preferably 10 days or less, more preferably 5 days or less, particularly preferably 3 days or less.

In this embodiment, through the storage at the predetermined temperature for the predetermined period of time, the viscosity of the fermented milk is increased after the storage as compared to that before the storage by desirably 1,000 cp or more, more desirably 2,000 cp or more, and particularly desirably 3,000 cp or more. In addition, the viscosity of the fermented milk is increased after the storage as compared to that before the storage by desirably 15,000 cp or less, more desirably 14,000 cp or less, and particularly desirably 13,000 cp or less.

The viscosity at 10° C. of the fermented milk after the storage is preferably 4,000 cp or more, more preferably 6,000 cp or more, and particularly preferably 8,000 cp or more. In addition, the viscosity at 10° C. of the fermented milk after the storage is preferably 20,000 cp or less, more preferably 16,000 cp or less, and particularly preferably 12,000 cp or less.

The production method for a two-layer-type fermented dairy product that includes a layer of a sauce containing fruit pulp or fruit juice on fermented milk and is contained in a container in this embodiment includes: supplying (i.e. charging, packing or filling) the fermented milk into the container at a supplying temperature of 15° C. or less; and supplying (i.e. charging, packing or filling) the sauce on the fermented milk after the supplying of the fermented milk.

In this case, the fermented milk to be supplied into the container at a supplying temperature of 15° C. or less may be any fermented milk produced in the above-mentioned embodiment.

According to this embodiment, high-viscosity physical properties can be expressed without unnecessarily increasing a milk solid or using any stabilizer in production steps for fermented milk.

In addition, when fermented milk having a high viscosity is produced without using any stabilizer, there can be produced a two-layer-type fermented dairy product capable of maintaining two layers even when a sauce containing, for example, fruit pulp or fruit juice is supplied on the fermented milk.

According to this embodiment, when no stabilizer is used for the preparation of fermented milk, there can be produced fermented milk exhibiting a natural flavor and texture while being thick.

In addition, without the use of any stabilizer in the preparation of fermented milk, there can be produced a fermented dairy product capable of maintaining two layers even when a sauce containing, for example, fruit pulp or fruit juice is supplied on the fermented milk.

Further, according to this embodiment, the storage is performed at low temperature, and hence fermented milk having less sourness can be preserved, and a product can be shipped by being supplied as needed in accordance with demand. Thus, an improvement in production efficiency is achieved.

### EXAMPLES

### Example 1

The temperature of fermented milk after concentrating and storage (i.e. aging) were adjusted as described below in the production of concentrated fermented milk by performing a concentrating step (i.e. whey removal) after fermentation, and the production of a two-layer-type fermented dairy product using the concentrated fermented milk after its production, in accordance with the production flow illustrated in FIG. 1, as described in the above-mentioned embodiment.

In hitherto generally performed production steps, the supplying temperature of concentrated fermented milk is about 20° C., and hence, in a balance tank or surge tank before a filling (i.e. supplying) machine, the temperature of the concentrated fermented milk is generally controlled to be nearly equal to the supplying temperature.

In this Example, fermented milk after the concentrating illustrated in FIG. 1 was cooled to 20° C. or less, and then stored (i.e. aged) in a surge tank at 15° C. or less for a certain period of time. In the aging process, the concentrated fermented milk was stirred several times with a large pitched blade.

In Table 2, the temperature and viscosity of the fermented milk in the surge tank are shown.

Through (i.e. by means of) 1 hour or more of aging after the storage, a thickening of 1,300 cp was found.

In addition, the fermented milk immediately after the storage and the fermented milk aged for 1 hour or more were subjected to sensory evaluation. As a result, it was revealed that the aging increased a thick feeling.

It was able to be confirmed that the storage temperature of the concentrated fermented milk influenced the viscosity.

TABLE 2

| | Temperature (° C.) | Viscosity (cp) |
|---|---|---|
| Immediately after storage | 12 | 4,650 |
| After 1 hour of standing still | 12 | 5,950 |
| After 2 hours of standing still | 15 | 6,160 |
| After 10 minutes of stirring | 11 | 6,660 |
| After 1 hour of standing still | 15 | 6,780 |
| After 2 hours of standing still | 13 | 6,720 |
| After 15 minutes of stirring | 14 | 6,730 |
| After 20 hours from storage | 11 | 9,120 |

### Example 2

A supplying temperature was adjusted as described below in the production of concentrated fermented milk by performing a concentrating step (i.e. whey removal) after fermentation, and the production of a two-layer-type fermented dairy product using the concentrated fermented milk after its production, in accordance with the production flow illustrated in FIG. 1, as described in the above-mentioned embodiment.

The fermented milk aged in the surge tank for 12 hours was used and supplied into a container with the supplying temperature being adjusted.

The viscosity of the fermented milk immediately after the supplying was measured. As a result, as shown in Table 3, it was able to be confirmed that “10° C. supplying” (liquid temperature of fermented milk at time of supplying: 10° C.) enabled supplying without reducing the viscosity which had been increased by the aging as compared to “20° C. supplying” (liquid temperature of fermented milk at time of supplying: 20° C.). Thus, it was able to be confirmed that the supplying temperature influenced the viscosity of the fermented milk.

TABLE 3

| | 10° C. | 20° C. |
|---|---|---|
| | supplying | supplying |
| Viscosity during storage in surge tank (cp) | 9,230 | 9,120 |
| (storage at 15° C. or less for 12 hours) | | |
| Viscosity of fermented milk immediately | 7,400 | 4,600 |
| after supplying into container (cp) | | |

### Example 3

A concentrated fermented milk was produced by performing a concentrating step (i.e. whey removal) after fermentation, and a two-layer-type fermented dairy product was produced using the concentrated fermented milk after its production, in accordance with the production flow illustrated in FIG. 1, as described in the above-mentioned embodiment.

In this Example, in light of the investigation of Example 2, 10° C. supplying and 20° C. supplying were performed.

84 g of concentrated fermented milk was supplied into a container, and immediately after that, 36 g of a banana sauce was supplied. The external appearance of the two-layer-type fermented dairy product was evaluated.

The banana sauce contained 40.0 mass % of banana fruit pulp, 15.0 mass % of sugar, 0.2 mass % of LM pectin, and water.

A spool nozzle filling machine FX-01 (manufactured by Shikoku Kakoki Co., Ltd.) was used for the supplying of the sauce.

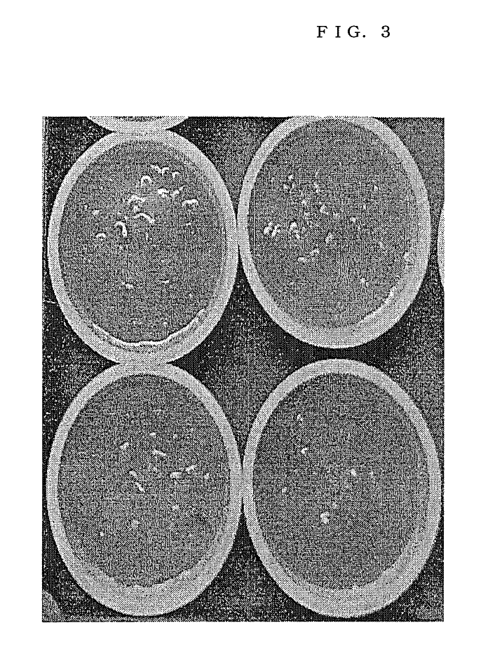

As a result, in the case of the 10° C. supplying, as shown in FIG. 3, the sauce spread as an upper layer on the fermented milk, and thus the two-layer-type fermented dairy product was able to be produced.

Meanwhile, in the case of the 20° C. supplying, the spreadability of the sauce was poor, and the fermented milk serving as a lower layer was partially seen from above.

It was able to be confirmed that the supplying temperature influenced the supplying suitability of the two-layer-type fermented milk in which the sauce was positioned as the upper layer.

### Example 4

A concentrated fermented milk was produced by performing a concentrating step (i.e. whey removal) after fermentation, and a two-layer-type fermented dairy product was produced using the concentrated fermented milk after its production, in accordance with the production flow illustrated in FIG. 1, as described in the above-mentioned embodiment.

Samples obtained by storing fermented milk after concentrating in a surge tank at 15° C. and 20° C., respectively, for 5 days were subjected to sensory evaluation. As a result, the 15° C. storage did not cause a problem with flavor, but the 20° C. storage increased sourness and remarkably changed quality.

It was able to be confirmed that the storage temperature in the surge tank influenced the flavor of the concentrated fermented milk.

The embodiment and Examples of the present invention have been described above, but the present invention is not limited thereto and may be variously modified within the technical scope grasped from the description of the claims.

1. A production method for fermented milk, comprising:
cooling fermented milk after concentrating; and
storing the fermented milk at a predetermined temperature for a predetermined period of time to increase a viscosity of the fermented milk.

2. The production method for fermented milk according to claim 1, wherein the concentrating of the fermented milk before the cooling is performed using a separator or a UF membrane.

3. The production method for fermented milk according to claim 1, wherein the predetermined temperature is 15° C. or less.

4. The production method for fermented milk according to claim 1, wherein the predetermined period of time is 1 hour or more.

5. The production method for fermented milk according to claim 1, wherein, through the storing at the predetermined temperature for the predetermined period of time, the viscosity of the fermented milk is increased after the storing as compared to that before the storing by 1,000 cp or more.

6. The production method for fermented milk according to claim 5, wherein the viscosity of the fermented milk after the storing is 4,000 cp or more.

7. A production method for a two-layer-type fermented dairy product that comprises a layer of a sauce containing fruit pulp or fruit juice on fermented milk and is contained in a container, the production method comprising:
supplying the fermented milk into the container at a supplying temperature of 15° C. or less; and
supplying the sauce on the fermented milk after the supplying of the fermented milk.

8. The production method for a two-layer-type fermented dairy product according to claim 7, wherein the fermented milk is produced by:
cooling the fermented milk after concentrating; and
storing the fermented milk at a predetermined temperature for a predetermined period of time to increase a viscosity of the fermented milk.
